(19) United States
(12) Patent Application Publication
(10) Pub. No.: US 2003/0160038 A1
(43) Pub. Date: Aug. 28, 2003

(54) Aid for welding or cutting

(76) Inventor: Dennis J. O'Connell, Box Hill (AU)

Correspondence Address: TOD R. NISSLE, P.C., P.O. Box 55630, Phoenix, AZ, 85078, US

(21) Appl. No.: 10/281,896

(22) Filed: Oct. 25, 2002

Related U.S. Application Data
(63) Continuation-in-part of application No. PCT/AU00/00789, filed on Jun. 30, 2000.

(30) Foreign Application Priority Data
Jul. 5, 2001 (WO) PCT/AU01/00800
Apr. 26, 2000 (WO) PCT/AU00/00789

(51) Int. Cl. B23K 9/00

(52) U.S. Cl. 219/147; 219/137 R

(57) ABSTRACT

the invention provides methods of aiding visibility in welding or high temperature cutting operations by interposing light and/or polarising filters between the work area and the operator. The methods do not use workpiece marking to enhance visibility or use only conventional workpiece markers, e.g. chalk, which do not actively emit light by luminescent activity.

### FIELD OF THE INVENTION

This invention relates to products and methods for aiding welding or high temperature cutting operations.

### BACKGROUND OF THE INVENTION

Prior to welding or high temperature cutting operations, it is known to use chalk as a marker for creating markings on a workpiece, such as the path which the weld or cut is to follow. However the mask which the operator interposes to protect the eyesight includes a dark filter to substantially attenuate the very intense electromagnetic radiation from the welding or cutting site. This can make it very difficult or impossible for the operator to see the chalk markings during the welding or cutting operation. As a result the weld or cut is frequently inaccurate and sometimes it is necessary for the operation to be performed again to achieve the required standard of accuracy or neatness. Also, the difficulty of seeing the chalk markings often means that the operator stops the operation, removes the mask to inspect the progress of the operation before resuming. These interruptions can significantly increase the time taken for the welding or cutting operation.

### OBJECT OF THE INVENTION

It is an object of the present invention to provide products and methods which can enable a person carrying out a welding or high temperature cutting operation to see markings on a workpiece during the welding or cutting operation.

### SUMMARY OF THE INVENTION

According to a first aspect of the invention there is provided a workpiece marker for use in a welding or high temperate cutting operation, the marker including a luminescent material in a form or medium for application to a workpiece, the luminescent material having the property of enabling creation of markings on the workpiece which are visible during the welding or cutting operation through eyesight protecting means of the operator to thereby provide a visible aid for the welding or cutting operation.

According to a second aspect of the invention there is provided a welding or cutting aid system for aiding a welding or high temperature cutting operation, the system including: a workpiece marker which includes a luminescent material in a form or medium for application to a workpiece, the luminescent material having the property of enabling creation of markings on the workpiece which are visible during the welding or cutting operation through eyesight protecting means of the operator, and a light filter to be interposed in use between the workpiece and the operator's eyes, the light filter being translucent to a band of frequencies which includes the frequency or frequencies of visible light emission of the luminescent material of the marker, the light filter substantially attenuating radiation at frequencies spaced from said band of frequencies.

According to a third aspect of the invention there is provided a method of aiding a welding or high temperature cutting operation being carried out on a workpiece, the method including the steps of: applying to the workpiece a luminescent material so as to create markings on the workpiece at locations intended to guide or inform an operator monitoring or controlling the welding or cutting operation, the luminescent material having the property of emitting visible radiation, when excited curing the welding or cutting operation, and conducting a welding or high temperature cutting operation on the workpiece while viewing the workpiece through an eyesight protector apparatus, the eyesight protector apparatus being translucent to a band of frequencies which includes the frequency or frequencies of visible light emission of the luminescent material, and controlling the welding or cutting operation in accordance with the visible markings of luminescent material on the workpiece.

### DESCRIPTION OF THE PREFERRED EMBODIMENTS

In the embodiments of the invention, preferably the luminescent material which enables creation of markings on the workpieces emits radiation in the visible spectrum upon excitation during the welding or cutting operation. In particular, it is preferable that the welding or cutting operation generates the exciting radiation which stimulates the luminescent material to emit the visible radiation.

The products and methods of the present invention are particularly applicable to arc welding including stick welding, TIG welding and MIG welding or plasma cutting operations. It is possible that the principles of the invention may be applicable to other types of welding or cutting operations but the radiation generated in other types of welding and cutting may not be as readily amenable to stimulating or exciting a luminescent material to emit sufficient light in the visible part of the spectrum. In the preferred or expected principal field of use in which the welding or cutting operation includes generation of an electric arc, the radiation being emitted by the arc preferably constitutes the exciting radiation which impinges on the luminescent material to stimulate it to emit the visible radiation. For example, the luminescent material may be excited by ultraviolet radiation emitted by the electric arc to emit the visible radiation.

The luminescent material may be a fluorescent material, or may be a phosphorescent material.

Preferably the luminescent material emits visible radiation in the middle or higher wavelengths of the visible spectrum, particularly in the yellow to orange to red regions of the visible spectrum. The luminescent material may for example emit light predominantly in the range of wavelengths from 580 nm to 660 nm, e.g. primarily at or around about 620 nm (orange-red). The yellow to orange to red region of the visible spectrum is preferred since it is found that these colours are more readily visible in or through the fume or smoke created during the welding or cutting operations than colours towards the blue-violet end of the spectrum.

Suitable luminescent materials can be chosen from organic and inorganic materials, and from liquid or solid formulations, having the required excitation and emission properties. Organic dyes known as “daylight fluorescent pigments” can provide suitable markers. Rhodamine and fluorescein dyes may be suitable, although specific and optimum fluorescent materials have not been identified at his stage of development. It is expected however that an ordinarily skilled chemist could readily identify suitable materials by reference to published properties for luminescent materials or by routine empirical testing.

The workpiece marker preferably further includes a filler mixed with the luminescent material. The filler may be a solid material whereby the workpiece marker can be held by hand and manipulated by a user to apply the markings to the workpiece. Preferably, the filler itself creates a marking on the workpiece which is visible in daylight or other illumination conditions enabling human visibility of the markings formed by the filler. The filler may comprise chalk in a particulate form mixed with the luminescent material. In the case of a luminescent material in solid solution or suspended in a solid transparent material such as an organic resin, the chalk may be mixed in a proportion of 60% by weight with 40% by weight of the resin/luminescent material particles.

The workpiece marker may further include a binder which binds the luminescent material in a solid form which can be held and manipulated by a user to apply the markings to the workpiece. The binder may comprise a resin material which is substantially translucent to the visible radiation emitted by the luminescent material making the markings on the workpiece visible during the welding or cutting operation. A suitable resin binder may be a thermosetting or thermoplastic resin binder. Melamine sulphonamide formaldehyde resin may be suitable as a carrier or median for the luminescent material and/or as a binder for the chalk and active material mixture.

As mentioned above in the summary of the invention, the second aspect of the invention provides a welding or cutting aid system for aiding a welding or high temperature cutting operation, the system including; a workpiece marker which includes a luminescent material in a form or medium for application to a workpiece, the luminescent material having the property of enabling creation of markings on the workpiece which are visible during the welding or cutting operation through eyesight protecting means of the operator, and a light filter to be interposed in use between the workpiece and the operator's eyes, the light filter being translucent to a band of frequencies which includes the frequency or frequencies of visible light emission of the luminescent material of the marker, the light filter substantially attenuating radiation at frequencies spaced from said band of frequencies.

The light filter preferably includes a panel of coloured light filter material to be interposed in use between the workpiece and the eyes of the operator, the panel being arranged to be mounted by the eyesight protecting means through which the operator views the welding or cutting operation. In the case of a conventional eyesight protecting means which comprises a mask having a window through which the operator views the welding or cutting operation, the window is provided with a dark filter medium interposed in the light path to reduce the intensity of light from the welding or cutting operation reaching the operator's eyes, and is also provided with the light filter additionally interposed in the light path from the site of the welding or cutting operation to the operator's eyes. The dark filter may be the conventional dark glass which cuts out ultraviolet and infrared radiation and substantially attenuates visible radiation so as to protect the operator's eyes. The light filter can be also a panel, e.g. of the standard 180 mm by 50 mm size, to fit into the mountings provided by welder's masks for the dark filter. The light filter is desirably selected to pass light at frequencies or wavelengths which the dark filter also passes and also if desired to substantially attenuate UV and/or IR radiation. The frequencies that the light filter passes preferably match the visible emission frequencies of the luminescent material. For example for luminescent material emitting at a wavelength of about 620 nm, an orange-red light filter would be preferred.

The light filter may be a lighting gel of the kind used for projecting coloured light such as in theatre stage lighting, the lighting gel having a characteristic colour substantially matched to the colour of visible light emission of the luminescent material. For the suggested orange-red luminescent material emissions, an “Amber-rose No. 22” gel filter is suitable.

The light filter enhances the visibility of the markings on the workpiece by attenuating or cutting out other wavelengths and helping the operator's eyes be more sensitive to the wavelength of the emissions from the luminescent material.

Also as mentioned above in the summary of the intention, the third aspect of the invention provides a method of aiding a welding or high temperature cutting operation being carried out on a workpiece, the method including the steps of: applying to the workpiece a luminescent material so as to create markings on the workpiece at locations intended to guide or inform an operator monitoring or controlling the welding or cutting operation, the luminescent material having the property of emitting visible radiation, when excited during the welding or cutting operation, and conducing a welding or high temperature cutting operation on the workpiece while viewing the workpiece through an eyesight protector apparatus, the eyesight protector apparatus being translucent to a band of frequencies which includes the frequency or frequencies of visible light emission of the luminescent material, and controlling the welding or cutting operation in accordance with the visible markings of luminescent material on the workpiece.

The most common situation for application of the method of the invention would be where the visible markings applied to the workpiece define or at least include a welding or cutting path which the welding or cutting operation is to follow. However, other marks such as prompts for the nature or location of the welds and/or cuts can also be used.

In the preferred method, the step of, applying markings comprises the application of markings to the workpiece using a workpiece marker according to the first aspect of the invention.

Likewise in the preferred method the steps of applying the markings and conducting the welding or cutting operation comprises using an aid system according to the second aspect of the invention by application of markings to the workpiece using the workpiece marker of the aid system and interposing the light filter in the light path during the welding or cutting operation.

It is to be understood that various alterations, modifications and/or additions may be made to the features of the possible and preferred embodiment(s) of the invention as herein described without departing from the spirit and scope of the invention as defined in the following claims.

### FIELD OF THE INVENTION

This invention relates to methods and products for aiding welding or high temperature cutting operations.

### BACKGROUND OF THE INVENTION

Prior to welding or high temperature cutting operations, it is known to use chalk as a marker for creating markings on a workpiece, such as the path which the weld or cut is to follow. However the mask which the operator interposes to protect the eyesight includes a dark filter to substantially attenuate the very intense electromagnetic radiation from the welding or cutting site. This can make it very difficult or impossible for the operator to see the chalk markings during the welding or cutting operation. As a result, the weld or cut is frequently inaccurate and sometimes it is necessary for the operation to be performed again to achieve the required standard of accuracy or neatness. Also, the difficulty of seeing the chalk markings often means that the operator stops the operation, removes the mask to inspect the progress of the operation before resuming. These interruptions can significantly increase the time takes for the welding or cutting operation

In my earlier Australian patent application No. AU-30119/00 and the International application PCT/AU00/00789, I have described several aspects of products and methods I have developed for aiding welding or high temperature cutting operations.

In particular, in those earlier patent applications, I described three aspects of my invention, the first aspect being a workpiece marker which includes a luminescent material, a second aspect which provides a welding or cutting aid system using the marker and a light filter translucent to visible light emitted by the luminescent marker, and a third aspect comprising a method of aiding a welding or high temperature cutting operation by applying a luminescent material to a workpiece and conducting a welding or cutting operation while viewing the workpiece through apparatus translucent to the wavelength of visible light emitted by the luminescent material.

More particularly, in my earlier patent applications, the first aspect of the invention provides a workpiece marker for use in a welding or high temperature cutting operation, the marker including a luminescent material in a form or medium for application to a workpiece, the luminescent material having the property of enabling creation of markings on the workpiece which are visible during the welding or cutting operation through eyesight protecting means of the operator to thereby provide a visible aid for the welding or cutting operation.

The second aspect of the earlier invention, provides a welding or cutting aid system for aiding a welding or high temperature cutting operation, the system including: a workpiece marker which includes a luminescent material in a form or medium for application to a workpiece, the luminescent material having the property of enabling creation of markings on the workpiece which are visible during the welding or cutting operation through eyesight protecting means of the operator, and a light filter to be interposed in use between the workpiece and the operator's eyes, the light filter being translucent to a band of frequencies which includes the frequency or frequencies of visible light emission of the luminescent material of the marker, the light filter substantially attenuating radiation at frequencies spaced from said band of frequencies.

The third aspect of the earlier invention provides a method of aiding a welding or high temperature cutting operation being carried out on a workpiece, the method including the steps of: applying to the workpiece a luminescent material so as to create markings on the workpiece at locations intended to guide or inform an operator monitoring or controlling the welding or cutting operation, the luminescent material having the property of emitting visible radiation, when excited during the welding or cutting operation, and conducting a welding or high temperature cutting operation on the workpiece while viewing the workpiece through an eyesight protector apparatus, the eyesight protector apparatus being translucent to a band of frequencies which includes the frequency or frequencies of visible light emission of the luminescent material, and controlling the welding or cutting operation in accordance with the visible markings of luminescent material on the workpiece.

### OBJECT OF THE INVENTION

It is an object of the present invention to provide method, for carrying out a welding or high temperature cutting operation with improved visibility of the work area.

It is a further object of the present invention to provide products when used for aiding a welding or high temperature cutting operation to enhance visibility of the work area.

### SUMMARY OF THE INVENTION

Broadly the present invention provides methods of aiding visibility in welding or high temperature cutting operations by interposing filters between the work area and the operator, but either without using workpiece marking to enhance visibility or using only conventional workpiece markers, e.g. chalk, which do not actively emit light bit luminescent activity.

According to a fist aspect of the present invention, there is provided a method of aiding a welding or high temperature cutting operation at a work area, which operation is being monitored, performed or controlled by al operator, the method including the steps of:

providing a light filter which is translucent to visible light in at least part of the yellow-orange-red region of the visible spectrum and which attenuates light at wavelengths shorter than yellow light, including strongly attenuating light in the blue-violet regions of the visible spectrum, and which attenuates light at shorter wavelengths into the ultraviolet region of the electromagnetic spectrum, and

interposing the light filter in the light path from the work area where the operator is monitoring, performing or controlling the welding or high temperature cutting operation and the operator, the welding or high temperature cutting operation being carried out on a workpiece in the work area which is not marked in any way to create light emission by the markings in the yellow-orange-red region of the spectrum.

According to a second aspect of the present invention there is provided a method of aiding a welding or high temperature cutting operation at a work area, which operation is being monitored, performed or controlled by an operator, the method including the step of interposing a polarising light filter in the light path from the work area to the operator, the direction or directions of light polarisation of the polarising filter being arranged to attenuate partially polarised light arising from scattering, diffuse reflection, or specular reflection in the vicinity of the work area.

### DESCRIPTION OF THE PREFERRED EMBODIMENTS

As summarised above, the system of the first aspect of the invention uses a light filter which is translucent to visible light in at least part of the yellow-orange-red region of the visible spectrum and which attenuates light wavelengths shorter than yellow light including strongly attenuating light in the blue region of the spectrum and at shorter wavelengths into the ultraviolet region of the electromagnetic spectrum. The light filter in use is interposed between a workpiece on which a welding or high temperature cutting operation is being performed and the operator.

In referring to “an operator” performing or controlling the welding or high temperature cutting operation, primarily I am referring to a person caring out the operation. However the “operator” may comprise a machine vision system including for example a camera for capturing an image of the work site and for generating image data signals for machine processing to monitor, perform or control the welding operation or for display of an image of the work site on a screen enabling a human operator to view the screen and monitor, perform or control the operation. In the case of a machine vision system comprising the “operator” the light filter is in use interposed between the workpiece and the image capture means, such as the camera lens, to thereby enhance the ability of the machine vision system to discriminate or differentiate light in the yellow-orange-red region of the spectrum. This broad meaning of the term “operator” is intended throughout this specification, including references to the invention in my earlier patent application, unless specific reference to a “human operator” is made.

In a preferred embodiment according to the first aspect of the invention, the welding or cutting aid system comprises an eyesight protecting means which is to be used by the human operator in monitoring, performing or controlling the welding or high temperature cutting operation, the eyesight protecting means providing a light attenuating main filter to protect the human operator's eyes from strong light including ultraviolet, visible and infrared light from the work area, the light filter which passes visible light in at least part of he yellow-orange-red region of the specimen being also provided by the eyesight protecting means so as to be interposed in the light path from the work area to the human operator's eyes. For example, the eyesight protecting means may comprise a welder's mask or goggles having as the main filter a conventional welding glass through which the human operator views the work area, with the yellow-orange-red light filter being additionally mounted by the eyesight protecting means so as to be additionally interposed in the light path.

In the preferred method there is provided an eyesight protecting means which includes a light attenuating main filter to attenuate strong light from the work area reaching the human operator's eyes, including strongly attenuating radiation in the ultraviolet and infrared regions of the electromagnetic spectrum, the eyesight protecting means mounting the light filter translucent to yellow-orange-red light so as to be also interposed in the light path from the work area to the human operator's eyes.

In performing the method according to this first aspect of the invention, instead of no markings being applied to the workpiece, there may also be provided a step of applying to the workpiece markings at locations intended to guide or inform the operator, the markings having the property of reflecting visible light in at least part of the yellow-orange-red region of the spectrum whereby such light from the marking passes through the light filter. However, such markings are not luminescent as in my previous patent applications—the markings can be by conventional markers, such as chalk. That is, the workpiece in the work area is marked with a conventional marker to enhance light reflection through a wide part of the visible spectrum, but the marker is not being operative to emit visible light in the yellow-orange-red region of the spectrum by luminescent activity.

To further explain background to the first aspect of the invention, the visibility of a gas metal arc welding process can be very poor when viewed through a conventional welder's low density light filter (e.g. No. 8 or 9). The view of the work area is obscured by the very bright fume surround the arc. This glare marks the underlying details and produce an uncomfortable level of glare. The scatting of light by small particles is a common occurrence, and generally the extent of scattering increases rapidly with decreasing wavelengths. The fume surrounding a welding arc has a blue colour indicating that it scatters much more blue light than red light, which is consistent with increasing scatter at decreasing wavelength. It is presumed that the scattering of UV light might be even stronger. This increased scatter of shorter wavelengths, particularly UV light, can be beneficial for the use of a luminescent material in markings applied to a workpiece because the UV excites the marker, and the fume diffuses, and thereby effectively enlarges, the size of the UV source. Further, the light diffusion by the fume acts as a “source” of UV located further above the work site than the arc and hence has a positive effect in exciting luminescent material spaced greater distances from the arc.

Unfortunately, this effect of the fume acting as an enlarged UV source is not very useful by itself because the brightness of the fume obscures the features below it. In fact, the fume might be expected to be considerably brighter than the fluorescence it stimulates. Although increasing the welding shade provides more comfort to the welder it will not alter the brightness of the marker in relation to its surroundings.

However, the introduction of an orange filter matching the emission wavelength of the marker dramatically alters this situation. The filter effectively obscures the fume from the welder's view by reducing glare from the fume without significantly attenuating the fluorescence of the marker because the fume is predominantly blue and UV. This is a reason why the luminescent marker is preferably chosen ill my prior patent applications to fluoresce in the orange to red region of the spectrum.

Although still speculative about the mechanisms operating with the present invention, this description also explains why the filter is preferably used in combination with the luminescent marker if line markings enhancement is to be optimised.

However, in accordance with the present invention it ha; been found that the light filter translucent to light in at least part of the yellow-orange-red region of the spectrum by itself provides a comfortable and clear view of the welding process because it removes from view most of the fume. Therefore, the use of the light filter per se (without use of a luminescent market) provides according to the first aspect of the present invention, a useful and therefore desirable stand-alone item for welders' use.

As summarised above, the method according to the second aspect of the second invention, includes use of a polarising filter interposed between a workpiece on which a welding or high temperature cutting operation is being performed and the operator. The direction(s) of polarisation of the filter are chosen to attenuate at least partially polarised light which arises upon reflection, particularly diffuse reflection, from surfaces and fume in the vicinity of the site of the welding or high temperature cutting operation.

The references in connection with this second aspect of the present invention to “an operator” are to be interpreted in the same manner as described above in connection with the first aspect of the present invention. In particular, the expression “operator” encompasses not only a human operator but also a machine vision system.

In relation to the second aspect of the present invention, it is known that light scattered from small particles when viewed at right angles to the direction of the incident light is polarised at right angles to the direction of the incident light. Therefore, the intense light from the work site in a welding or high temperature cutting operation contains a proportion of polarised light from scattering and reflection from the workpiece and from the fume in the vicinity of the work site. By interposing a polariser having its direction of polarisation cross wise to the predominant direction of partial polarisation, the glare in the vicinity of the work site can be significantly reduced. By providing according to the second aspect of the present invention a polariser having the appropriate direction of polarisation and interposing it in the light path from the work site to the operator, the visibility of the work site and markings and features of the workpiece can be enhanced. The polarising filter can be used alone or, more preferably, in conjunction with the use of the light filter according to the first aspect of the present invention, and further preferably in conjunction with us of a luminescent material for providing markings on the workpiece according to my earlier patent applications.

Similarly to the preferred embodiment of the first aspect of the invention, the welding or cutting aid system according to the second aspect of the invention may comprise an eyesight protecting means providing a light attenuating main filter, the polarising filter being also provided by the eyesight protecting means so as to be interposed in the light path from the work area to the human operator's eyes.

In the second aspect of the invention, a luminescent material may be used for creation of markings on the workpieces and which emits radiation in the visible spectrum upon excitation during the welding or cutting operation. In particular, it is preferable that the welding or cutting operation generates the exciting radiation which stimulates the luminescent material to emit the visible radiation. For example, in arc welding, the electric arc emits radiation including ultraviolet radiation which is suitable for stimulating a luminescent material to emit light. However, it is also possible and within the scope of a third aspect of the invention to stimulate the luminescent material to emit radiation by generating ultraviolet light or other suitable radiation to impinge on the luminescent material by means other than the welding arc or the like. For example, there may be provided an ultraviolet light source which is powered during the welding or cutting operation and is arranged so that the UV light from the source is directed towards the workpiece having the markings. Tests with a ultraviolet tube emitting “soft” ultra violet radiation with a peak intensity at about 350 nm have confirmed the effectiveness of using this stimulating source. Possible benefits of using such an independent source of stimulating radiation can include (a) the stimulation of the luminescent material to emit its characteristic visible light at distances further from the work site where the welding or cutting operation is taking place (compared to the use of the radiation from the electric arc which will have a very low angle of incidence arising from the location of the arc substantially at the work surface or only millimetres above the work surface, with the result that use of the arc light to stimulate radiation from markings some distance from the work site can be relatively ineffective) and (b) the possibility of continuous excitation of the markings to emit the characteristic visible light even when the welding or cutting is stopped.

The products and methods of the present invention are particularly applicable to arc welding including stick welding, TIG welding and MIG welding or plasma cutting operations. It is possible that the principles of the second aspect of the invention may be applicable to other types of welding or cutting operations but the radiation generated in other types of welding and cutting may not be as readily amenable to stimulating or exciting a luminescent material to emit sufficient light hi the visible part of the spectrum. For such other types of welding or cutting, an independently powered source of stimulation radiation can be used. In the preferred or expected principal field of use in which the welding or cutting operation includes generation of an electric arc, the radiation being emitted by the arc preferably constitutes the exciting radiation which impinges on the luminescent material to stimulate it to emit the visible radiation. For example, the luminescent material may be excited by ultraviolet radiation emitted by the electric arc to emit the visible radiation.

The luminescent material may be a fluorescent material, or may be a phosphorescent material.

For reasons evident from preceding description, preferably the luminescent material emits visible radiation in the middle or higher wavelengths of the visible spectrum, particularly in the yellow to orange to red regions of the visible spectrum. The luminescent material may for example emit light predominantly in the range of wavelengths from 580 nm to 660 nm, e.g. primarily at or around about 620 nm (orange-red). The yellow to orange to red region of the visible spectrum is preferred since it is found that these colours are more readily visible in or through the fine or smoke created during the welding or cutting operations than colours towards the blue-violet end of the spectrum.

Suitable luminescent materials can be chosen from organic and inorganic materials, and from liquid or solid formulations, having the required excitation and emission properties. Organic dyes known as “daylight fluorescent pigments” can provide suitable markers. Commercially available daylight fluorescent pigments can comprise, for example, a solid solution of basic and solvent dyes in a resin binder. These pigments are supplied in the form of a powder and are available in various colours including for example, pink, magenta, yellow, orange, green, blue and violet. These pigments are generally considered non toxic—(see Encyclopaedia of Chemical Technology, by Kirk and Othmer, Third Edition, Volume 14, page 563). Rhodamine and fluorescein dyes may be suitable. It is expected however that an ordinarily skilled chemist could readily identify suitable materials by reference to published properties for luminescent materials or by routine empirical testing.

The workpiece marker preferably further includes a filler mixed with the luminescent material. The filler may be a solid material whereby the workpiece marker can be held by hand and manipulated by a user to apply the markings to the workpiece. Preferably, the filler itself creates a marking on the workpiece which is visible in daylight or other illumination conditions enabling human visibility of the markings formed by the filler. The filler may comprise chalk in a particulate form mixed with the luminescent material. In the case of a luminescent material in solid solution or suspended in a solid transparent material such as an organic resin, the chalk may be mixed in a proportion of 60% by weight with 40% by weight of the resin/luminescent material particles.

The workpiece marker may further include a binder which binds the luminescent material in a solid form which can be held and manipulated by a user to apply the markings to the workpiece. The binder may comprise a resin material which is substantially translucent to the visible radiation emitted by the luminescent material making the markings on the workpiece visible during the welding or cutting operation. A suitable resin binder may be a thermosetting or thermoplastic resin binder. Melamine sulphonamide formaldehyde resin may be suitable as a carrier or medium for the luminescent material and/or as a binder for the chalk and active material mixture.

The light filter preferably includes a panel of coloured light filter material to be interposed in use between the workpiece and the eyes of a human operator, the panel being arranged to be mounted by the eyesight protecting means through which the human operator views the welding or cutting operation. In the case of a conventional eyesight protecting means which comprises a mask having a window through which the human operator views the welding or cutting operation, the window is provided with a main dark filter medium interposed in the light path to reduce the intensity of light from the welding or cutting operation reaching the operator's eyes, and is also provided with the light filter additionally interposed in the light path from the site of the welding or cutting operation to the operator's eyes. The main dark filter may be the conventional dark glass which cuts out ultraviolet and infrared radiation and substantially attenuates visible radiation so as to protect the operator's eyes. The light filter can be also a panel, e.g. of the standard 108 mm by 50 mm size, to fit into the mountings provided by welder's masks for the dark filter. The light filter is desirably selected to pass light at frequencies or wavelengths which the dark filter also passes and also if desired to substantially attenuate UV and/or IR radiation. For example for passing light from the work area luminescent material emitting at a wavelength of about 620 nm, an orange-red light filter would be preferred

The light filter may be a lighting gel of the kind used for projecting coloured light such as used for creating lighting effects in theatre productions, the lighting gel having a characteristic colour substantially matched to the colour of visible light emission of the luminescent material. For the suggested orange-red luminescent material emissions, a Roscolux No. 22 deep amber supergel filter is suitable. These kinds of supergel filters are available as rolls of plastics sheet and therefore these are easily cut and adapted to be mounted by a welder's mask superimposed on the dark protective glass normally provided by the mask The suggested Roscolux No. 22 deep amber supergel filter has a transmission spectrum which includes strong attenuation of light at wavelengths shorter than about 590 nm and progressively increasing attenuation for wavelengths greater than about 700 nm. This transmission spectrum, therefore, is well matched to the recommended luminescent material emitting at a wavelength of about 620 nm.

Solid light filters, rather than gel filters, are also suitable.

The light filter enhances the visibility of the work area, including conventional (non-luminescent) markings on the workpiece by attenuating or cutting out other wavelengths particularly shorter wavelengths from scattered light and helping the operator's eyes or machine operator's vision system be mom sensitive to the light from the work area.

The most common situation expected for application of tea methods of my inventions would be where the visible markings applied to the workpiece define or at least include a welding or cutting path which the welding or cutting operation is to follow. However, other marks such as prompts for the nature or location of the welds and/or cuts can also be used. Particular examples of situations where the present invention is applicable include: welding here plates are butted tight without gap, welding intermittent welds, controlling weld bead width and fillet weld size, and marking zones where no welding is to be performed. Using workpiece marking, preferably in the second aspect with luminescent components in the marking, and using the light filtering, preferably in the yellow-orange-red region of the visible spectrum, and using the polarising filtering, provide excellent visual aids to welding and cutting operations. These benefits apply not only for assisting welders generally but can be particularly applicable in training welders and in improving the skill or performance of welders have sight deficiency (a common problem with welders after many years of performing such work).

1. A workpiece marker for use in a welding or high temperature cutting operation, the marker including a luminescent material in a form or medium for application to a workpiece, the luminescent material having the property of enabling creation of markings on the workpiece which are visible during the welding or cutting operation through eyesight protecting means of the welder to thereby provide a visible aid for the welding or cutting operation.

2. A workpiece marker as claimed in claim 1 wherein the luminescent material emits radiation in the visible spectrum upon excitation during the welding or cutting operation.

3. A workpiece marker as claimed in claim 2 wherein the welding or cutting operation generates the exciting radiation which stimulates the luminescent material to emit the visible radiation.

4. A workpiece marker as claimed in claim 3 wherein the welding or cutting operation includes generation of an electric arc, the radiation being emitted by the arc constituting the exciting radiation which impinges on the luminescent material to stimulate it to emit the visible radiation.

5. A workpiece marker as claimed in claim 4 wherein the luminescent material is excited by ultraviolet radiation emitted by the electric arc to emit the visible radiation.

6. A workpiece marker as claimed in any one of the preceding claims wherein the luminescent material is a fluorescent material.

7. A workpiece marker as claimed in claim 1 wherein the luminescent material is a phosphorescent material.

8. A workpiece marker as claimed in claim 1 wherein the luminescent material emits visible radiation in the middle or higher wavelengths of the visible spectrum.

9. A workpiece marker as claimed in claim 8 wherein the luminescent material emits visible radiation in the yellow to orange to red regions of the visible spectrum.

10. A workpiece marker as claimed in claim 1 and further including a filler mixed with the luminescent material.

11. A workpiece marker as claimed in claim 10 wherein the filler is a solid material whereby the workpiece marker can be held by hand and manipulated by a user to apply the markings to the workpiece.

12. A workpiece marker as claimed in claim 10 wherein the filler itself creates a marking on the workpiece which is visible in daylight or other illumination conditions enabling human visibility of the markings formed by the filler.

13. A workpiece marker as claimed in claim 10 wherein the filler comprises chalk in a particulate form mixed with the luminescent material.

14. A workpiece marker as claimed in claim 1 and further including a binder which binds the luminescent material in a solid form which can be held and manipulated by a user to apply the markings to the workpiece.

15. A workpiece marker as claimed in claim 14 wherein the binder comprises a resin material which is substantially translucent to the visible radiation emitted by the luminescent material making the markings on the workpiece visible during the welding or cutting operation.

16. A welding or cutting aid system for aiding a welding or high temperature cutting operation, the system including:
a workpiece marker which includes a luminescent material in a form or medium for application to a workpiece, the luminescent material having the property of enabling creation of markings on the workpiece which are visible during the welding or cutting operation through eyesight protecting means of the operator, and
a light filter to be interposed in use between the workpiece and the operator's eyes, the light filter being translucent to a band of frequencies which includes the frequency or frequencies of visible light emission of the luminescent material of the marker, the light filter substantially attenuating radiation at frequencies spaced from said band of frequencies.

17. A system as claimed in claim 16 wherein the light filter includes a panel of coloured light filter material to be interposed in use between the workpiece and the eyes of the operator, the panel being arranged to be mounted by the eyesight protecting means through which the operator views the welding or cutting operation.

18. A system as claimed in claim 17 wherein the eyesight protecting means comprises a mask having a window through which the operator views the welding or cutting operation, the window being provided with a dark filter medium interposed in the light path to reduce the intensity of light from the welding or cutting operation reaching the operator's eyes, the light filter being additionally interposed in the light path from the site of the welding or cutting operation to the operator's eyes.

19. A system as claimed in claim 17 wherein the light filter is a lighting gel of the kind used for projecting coloured light such as in theatre stage lighting, the lighting gel having a characteristic colour substantially matched to the colour of visible light emission of the luminescent material.

20. A system as claimed in claim 16 wherein the marker consists of a workpiece marker as claimed in claim 2.

21. A method of aiding a welding or high temperature cutting operation being carried out on a workpiece, the method including the steps of:
applying to the workpiece a luminescent material so as to create markings on the workpiece at locations intended to guide or inform an operator monitoring or controlling the welding or cutting operation, the luminescent material having the property of emitting visible radiation, when excited during the welding or cutting operation, and
conducting a welding or high temperature cutting operation on the workpiece while viewing the workpiece through an eyesight protector apparatus, the eyesight protector apparatus being translucent to a band of frequencies which includes the frequency or frequencies of visible light emission of the luminescent material, and controlling the welding or cutting operation in accordance with the visible markings of luminescent material on the workpiece.

22. A method as claimed in claim 21 wherein the visible markings applied to the workpiece include a welding or cutting path which the welding or cutting operation is to follow.

23. A method as claimed in claim 21 wherein the step of applying markings comprises the application of markings to the workpiece using a workpiece marker as claimed claim 1.

24. A method as claimed in claim 21 wherein the steps of applying the markings and conducting the welding or cutting operation comprises using an aid system as claimed in claim 16 by application of markings to the workpiece using the workpiece marker of the aid system and interposing the light filter in the light path during the welding or cutting operation.

1. A workpiece marker for use in a welding or high temperature cutting operation, the marker including a luminescent material in a form or medium for application to a workpiece, the luminescent material having the property of enabling creation of markings on the workpiece which are visible during the welding or cutting operation through eyesight protecting means of the welder to thereby provide a visible aid for the welding or cutting operation.

2. A workpiece marker as claimed in claim 1 wherein the luminescent material emits radiation in the visible spectrum upon excitation during the welding or cutting operation.

3. A workpiece marker as claimed in claim 2 wherein the welding or cutting operation generates the exciting radiation which stimulates the luminescent material to emit the visible radiation.

4. A workpiece marker as claimed in claim 3 wherein the welding or cutting operation includes generation of an electric arc, the radiation being emitted by the arc constituting the exciting radiation which impinges on the luminescent material to stimulate it to emit the visible radiation.

5. A workpiece marker as claimed in claim 4 wherein the luminescent material is excited by ultraviolet radiation emitted by the electric arc to emit the visible radiation.

6. A workpiece marker as claimed in any one of the preceding claims wherein the luminescent material is a fluorescent material.

7. A workpiece marker as claimed in claim 1 wherein the luminescent material is a phosphorescent material.

8. A workpiece marker as claimed in claim 1 wherein the luminescent material emits visible radiation in the middle or higher wavelengths of the visible spectrum.

9. A workpiece marker as claimed in claim 8 wherein the luminescent material emits visible radiation in the yellow to orange to red regions of the visible spectrum.

10. A workpiece marker as claimed in claim 1 and further including a filler mixed with the luminescent material.

11. A workpiece marker as claimed in claim 10 wherein the filler is a solid material whereby the workpiece marker can be held by hand and manipulated by a user to apply the markings to the workpiece.

12. A workpiece marker as claimed in claim 10 wherein the filler itself creates a marking on the workpiece which is visible in daylight or other illumination conditions enabling human visibility of the markings formed by the filler.

13. A workpiece marker as claimed in claim 10 wherein the filler comprises chalk in a particulate form mixed with the luminescent material.

14. A workpiece marker as claimed in claim 1 and further including a binder which binds the luminescent material in a solid form which can be held and manipulated by a user to apply the markings to the workpiece.

15. A workpiece marker as claimed in claim 14 wherein the binder comprises a resin material which is substantially translucent to the visible radiation emitted by the luminescent material making the markings on the workpiece visible during the welding or cutting operation.

16. A welding or cutting aid system for aiding a welding or high temperature cutting operation, the system including:
a workpiece marker which includes a luminescent material in a form or medium for application to a workpiece, the luminescent material having the property of enabling creation of markings on the workpiece which are visible during the welding or cutting operation through eyesight protecting means of the operator, and
a light filter to be interposed in use between the workpiece and the operator's eyes the light filter being translucent to a band of frequencies which includes the frequency or frequencies of visible light emission of the luminescent material of the marker, the light filter substantially attenuating radiation at frequencies spaced from said band of frequencies.

17. A system as claimed in claim 16 wherein the light filter includes a panel of coloured light filter material to be interposed in use between the workpiece and the eyes of the operator, the panel being arranged to be mounted by the eyesight protecting means through which the operator views the welding or cutting operation.

18. A system as claimed in claim 17 wherein the eyesight protecting means comprises a mask having a window through which the operator views the welding or cutting operation, the window being provided with a dark filter medium interposed in the light path to reduce the intensity of light from the welding or cutting operation reaching the operator's eyes, the light filter being additionally interposed in the light path from the site of the welding or cutting operation to the operator's eyes.

19. A system as claimed in claim 17 wherein the light filter is a lighting gel of the kind used for projecting coloured light such as in theatre stage lighting, the lighting gel having a characteristic colour substantially matched to the colour of visible light emission of the luminescent material.

20. A system as claimed in claim 16 wherein the marker consists of a workpiece marker as claimed in claim 2.

21. A method of aiding a welding or high temperature cutting operation being carried out on a workpiece, the method including the steps of:
applying to the workpiece a luminescent material so as to create markings on the workpiece at locations intended to guide or inform an operator monitoring or controlling the welding or cutting operation, the luminescent material having the property of emitting visible radiation, when excited during the welding or cutting operation, and
conducting a welding or high temperature cutting operation on the workpiece while viewing the workpiece through an eyesight protector apparatus, the eyesight protector apparatus being translucent to a band of frequencies which includes the frequency or frequencies of visible light emission of the luminescent material, and controlling the welding or cutting operation in accordance with the visible markings of luminescent material on the workpiece.

22. A method as claimed in claim 21 wherein the visible markings applied to the workpiece include a welding or cutting path which the welding or cutting operation is to follow.

23. A method as claimed in claim 21 wherein the step of applying markings comprises the application of markings to the workpiece using a workpiece marker as claimed claim 1.

24. A method as claimed in claim 21 wherein the steps of applying the markings and conducting the welding or cutting operation comprises using an aid system as claimed in claim 16 by application of markings to the workpiece using the workpiece marker of the aid system and interposing the light filter in the light path during the welding or cutting operation.

25. A method of aiding a welding or high temperature cutting operation at a work area, which operation is being monitored, performed on controlled by an operator, the method including the steps of:
providing a light filter which is translucent to visible light in at least part of the yellow-orange-red region of the visible spectrum and which attenuates light at wavelengths shorter than yellow light, including strongly attenuating light in the blue-violet regions of the visible spectrum, and which attenuates light at shorter wavelengths into the ultraviolet region of the electromagnetic spectrum, and
interposing the light filter in the light path from the work area where the operator is monitoring, performing or controlling the welding or high temperature cutting operation and the operator, the welding or high temperature cutting operation being carried out on a workpiece in the work area which is not marked in any way to create light emission by the marking in the yellow-orange-red region of the spectrum.

26. A method as claimed in claim 25 wherein the workpiece in the work area is marked with a conventional marker to enhance light reflection through a wide part of the visible spectrum, the marker not being operative to emit visible light in the yellow-orange-red region of the spectrum by luminescent activity.

27. A method as claimed in claim 25 wherein the operator is a human operator and wherein the light filter is provided mounted in an eyesight protecting means which includes a light attenuating main filter to attenuate strong light from the work area reaching the human operator's eyes, including strongly attenuating radiation in the ultraviolet and infrared regions of the electromagnetic spectrum, the light filter translucent to yellow-orange-red light being also mounted by the eyesight protecting means so as to be also interposed in the light path from the work area to the human operator's eyes.

28. A method as claimed in claim 25 wherein the light filter has a transmission spectrum which includes strong attenuation of light at wavelengths shorter than about 590 nm and progressively increasing attenuation of wavelengths greater than about 700 nm.

29. A method as claimed in claim 28 wherein the light filter maximally transmits light at a wavelength of about 620 nm.

30. A method as claimed in any one of the preceding claims and further including the step of providing a polarising filter interposed in the light path from the work area to the operator, the direction or directions of polarisation of the polarising filter being arranged to attenuate at least partially polarised light which arises upon reflection, including diffuse reflection, from surfaces and fume in the vicinity of the work area.

31. A method as claimed in claim 30 wherein the polarising filter has its direction or directions of polarisation arranged crosswise to the predominant direction of partial polarisation of diffusely reflected light from fume in the work area so as to thereby reduce glare in the vicinity of the work area arising from light diffusely deflected from fume.

32. A method of aiding a welding or high temperature cutting operation at a work area, which operation is being monitored, performed or controlled by an operator, the method including the step of interposing a polarising light filter in the light path from the work area to the operator, the direction or directions of light polarisation of the polarising filter being arranged to attenuate partially polarised light arising from scattering, diffuse reflection, or specular reflection in the vicinity of the work area.

33. A method as claimed in claim 32 wherein the polarising filter has its direction or directions of polarisation arranged crosswise to the predominant direction of partial polarisation of diffusely reflected light from flume in the work area so as to thereby reduce glare in the vicinity of the work area arising from light diffusely deflect from fume.

34. A method as claimed in claim 32 wherein the welding or high temperature cutting operation is being performed on a workpiece, the workpiece not having any markings thereon to guide or provide information to the operator by enhancing light reflection or emission in the vicinity of the work area.

35. A method as claimed in claim 32 wherein the welding or high temperature cutting operation is being performed on a workpiece, the workpiece having markings thereon to guide or provide information to the operator by enhancing light reflection or emission in the vicinity of the work area.

36. A method as claimed in claim 35 wherein the making of the workpiece includes applying to the workpiece prior to the welding or high temperature cutting operation a conventional workpiece market to enhance light reflection through a wide part of the visible spectrum, the market not being operable to emit visible light in the yellow-orange-red region of the spectrum by luminescent activity.

37. A method as claimed in claim 35 wherein the marking of the workpiece includes applying to the workpiece prior to the welding or high temperature cutting operation a workpiece marker which includes a luminescent material, the luminescent material having the property of emitting light at a frequency or frequencies to enhance visibility of the work area.

38. A method as claimed in claim 37 and further including the step of interposing in the light path from the work area to the operator a light filter which is translucent to light the part of the visible spectrum at which the luminescent material of the marker emits.

39. A method as claimed in claim 38 wherein the light filter strongly attenuates light in the blue region of the spectrum and at shorter wavelengths into the ultraviolet region of the spectrum.

40. A method as claimed in claim 37 wherein the luminescent material of the marker emits light in the yellow-orange-red region of the visible spectrum

41. A light filter when used in a method as claimed in claim 25.

42. A polarising filter when used in a method as claimed in claim 32.

43. A method as claimed in claim 25 wherein the operation is an arc welding operation.
